(19) United States
(12) Patent Application Publication
(10) Pub. No.: US 2010/0203353 A1
(43) Pub. Date: Aug. 12, 2010

(54) Pb-Free Sn-Ag-Cu-Mn Solder

(75) Inventors: Iver E. Anderson, Ames, IA (US); Joel Harringa, Ames, IA (US); Jason K. Walleser, Idaho Falls, IA (US)

Correspondence Address: Edward J. Timmer, Suite 205, 121 East Front Street, Traverse City, MI, 49684, US

(73) Assignee: Iowa State University Research Foundation, Inc.

(21) Appl. No.: 12/456,853

(22) Filed: Jun. 23, 2009

Related U.S. Application Data
(60) Provisional application No. 61/207,015, filed on Feb. 6, 2009.

(51) Int. Cl. B32B 15/01; C22C 13/00

(52) U.S. Cl. 428/646; 420/560; 428/615; 228/101; 420/591

(57) ABSTRACT

A solder alloy comprises Sn, Ag, Cu, and Mn and has a melting temperature of about 211 degrees C. A solder joint and solder process embody the solder alloy as well as solder balls and solder paste made therefrom to provide a solidified joint that includes three different intermetallic phases and a Sn metal phase. An exemplary Sn—Ag—Cu—Mn alloy consists essentially of about 3 to about 4 weight % Ag, about 0.80 to about 1.0 weight % Cu, and about 0.05 to about 0.15 weight % Mn, and balance consisting essentially of Sn.

### RELATED APPLICATION

This application claims priority and benefits of U.S. provisional application Ser. No. 61/207,015 filed Feb. 6, 2009, the disclosure of which is incorporated herein by reference.

### CONTRACTUAL ORIGIN OF THE INVENTION

This invention was made with government support under Contract No. DE-ACO2-07CH11358 awarded by the U.S. Department of Energy. The government has certain rights in the invention.

### FIELD OF THE INVENTION

The present invention provides a Pb-free solder alloy (Sn—Ag—Cu—Mn) that displays an unexpectedly low melting point (about 211° C.) and minimal melting range (<about 6° C.), indicative of a quaternary eutectic and can be used as a low melting Pb-free solder alloy for joining electronic assemblies and electrical contacts and to substitute for Pb-containing solders in all surface mount solder assembly operations, including solder paste reflow and ball grid array joints.

### BACKGROUND OF THE INVENTION

The global electronic assembly community is striving to accommodate the replacement of Pb-containing solders, primarily Sn—Pb alloys, with Pb-free solders due to environmental regulations and market pressures. During this major transition away from eutectic or near-eutectic Sn—Pb solder (T_{eut.}=183° C.) for electronic assembly, there is also the opportunity to make a major improvement in Pb-free joint reliability for challenging operating environments, i.e., high temperatures and stress levels, as well as impact loading situations. Of the Pb-free choices, an array of solder alloys based on the Sn-3.7% Ag-0.9% Cu (in wt. %) ternary eutectic (T_{eut.}=217° C.) composition (known as SAC3709) have emerged with the most potential for broad use across the industry. U.S. Pat. No. 5,527,628 describes such Pb-free solder alloys.

An observation that arose from initial widespread testing of Sn—Ag—Cu (SAC) solder alloys was the occasional embrittlement of SAC solder joints due to micro-void nucleation, growth, and coalescence, if the exposure to elevated temperatures was sufficiently high, typically greater than about 150° C., and the exposure was sufficiently long, greater than about 500 to 1000 h (hours). This occasional joint embrittlement after thermal aging was observed at elevated Cu content in SAC solder alloys and typically was associated with excessive growth of layers of Cu-base intermetallic compounds, Cu₆Sn₅ and, especially, Cu₃Sn. It should be noted that U.S. Pat. No. 6,231,691 provides a solder to suppress this thermal aging phenomenon through minor additions (<1 wt. %, but usually 0.2-0.3 wt. %) of a fourth element, such as Ni, Fe, and/or Co, and “like-acting elements,” to the SAC solder to suppress solid state diffusion at the solder/substrate interface that contains the Cu-base intermetallic compound layers. Later testing (see reference A) showed that a 0.3 wt. % Mn substitutional addition to SAC3709 was one of the most effective like-acting elemental additions, suppressing growth of both types of intermetallic layers after extensive thermal aging. This type of minor alloy addition to prevent embrittlement has become increasingly important since narrow solder joint gaps are becoming more common with miniaturization of electronic circuits. (Reference A—I. E. Anderson and J. L. Harring a, “Suppression of Void Coalescence in Thermal Aging of Tin-Silver-Copper-X Solder Joints,” J. Elec. Mater. (2006), Vol. 35 (1), p. 1-13).

Studies have shown that Sn dendrites were the dominant as-solidified microstructure feature in solder joints made with many SAC alloys, not a fine (ternary) eutectic, contrary to the previous experience with Sn—Pb. Also, it was found that relatively high but variable undercooling was observed commonly before joint solidification, leading to Sn dendrites with spacing variations (that depend on undercooling and growth rate) but with very few distinct Sn grains. The unusually high undercooling of the SAC solder joints was associated with the difficulty of nucleating Sn solidification, as a pro-eutectic phase. Especially during slow cooling, e.g., in ball grid array (BGA) joints, increased undercooling of the joints also can promote formation of undesirable pro-eutectic intermetallic phases, specifically Ag₃Sn “blades,” that tend to coarsen radically, leading to embrittlement of as-solidified solder joints.

References 1, 2, 3, and 4 listed below employed fourth element additions to SAC solders with the intention of avoiding Ag₃Sn blades by selecting SAC compositions that were deficient in Ag and Cu, e.g., see SAC2705 [see ref 4], SAC305, and SAC105 [see refs. 1, 2, 3]. These references include the following:
1. W. Liu and N-C. Lee, “The Effects of Additives to SnAgCu Alloys on Microstructure and Drop Impact Reliability of Solder Joints,” JOM, 59, no. 7 (2007) pp. 26-31.
2. L-W. Lin et al., “Alloying modification of Sn—Ag—Cu solders by manganese and titanium,” Microelectron. Reliab. (2008), doi:10.1016/j.microrel.2008.10.001.
3. W. Liu, P. Bachorik, and N-C. Lee, “The Superior Drop Test Performance of SAC-Ti Solders and Its' Mechanism,” Proc 58^{th} Electronic Components and Technology Conf, (2008), pp. 627-635.
4. S. K. Kang, P. A. Lauro, D.-Y. Shih, D. W. Henderson, K. J. Puttlitz, IBM J. Res. Dev. 49(4/5), 607-620 (2005).

In these references, some marginally near-eutectic SAC alloy designs were proposed with a low Cu level (0.5%) and very low Ag levels, less than 2.7% Ag [ref. 4] and down to 1% Ag (SAC105). These base alloys were selected since they would tend to promote Sn formation and inhibit nucleation of Ag₃Sn [ref. 1, 2, 3, 4]. Because these alloys deviate increasingly from the eutectic, they exhibit a wider melting range (mushy zone) with a liquidus temperature (for SAC105) as high as 226° C. Unfortunately, some observations of unmodified SAC105 interfacial failure on impact loading still occurred, since occasional high undercooling still may permit Ag₃Sn blade formation during slow cooling. These “interfacial adhesion” failures prompted attempts at alloy modifications of SAC105 solder with 1-2 additions [refs. 1, 2] to improve impact resistance of BGA joints by increasing the interfacial bond strength of the intermetallic layer and, presumably, by suppressing Ag₃Sn blade formation. While significant improvement in impact resistance was observed, especially for SAC105+0.13Mn and SAC105+0.02Ti alloys [ref. 3] (and no Ag₃Sn blades were reported), their high liquidus temperature (approximately 226° C.) and wide mushy zone (equal to 9° C. because of the 217° C. solidus temperature) inhibits broad service application.

### SUMMARY OF THE INVENTION

In an embodiment, the present invention provides an alloy comprising Sn, Ag, Cu, and Mn and having a melting temperature of about 211 degrees C., which is well below the melting temperature of other SAC solder alloys. The alloy typically exhibits a liquid plus solid temperature range of less than about 6 degrees C., often less than about 4 degrees C.

An illustrative embodiment of the invention provides a Pb-free solder alloy consisting essentially of about 3 to about 4 weight % Ag, about 0.80 to about 1.0 weight % Cu, and about 0.05 to about 0.15 weight % Mn, and balance consisting essentially of Sn.

Another illustrative embodiment of the invention provides a Pb-free solder alloy consisting essentially of about 3 to about 4 weight % Ag, 0.95-y weight % Cu, and y weight % Mn and balance consisting essentially of Sn wherein y is about 0.05 to about 0.15 weight %.

A further illustrative embodiment of the invention provides a Pb-free solder alloy comprising Sn, Ag, Cu, and Mn and having four different phases including three different intermetallic phases and a Sn metal phase. For example, the intermetallic phases include a phase comprising Sn and Mn (probably MnSn₂), Cu₆Sn₅ phase, and Ag₃Sn phase.

The present invention also provides a solder joint and solder process that embody a Sn—Ag—Cu—Mn alloy of the type discussed above. The solder joint has a microstructure having four different phases including three different intermetallic phases and a Sn metal phase. For example, the intermetallic phases include a phase comprising Sn and Mn (probably MnSn₂), Cu₆Sn₅ phase, and Ag₃Sn phase. The Sn metal phase typically is β-Sn phase. The solder joint is formed by the solder being solidified on an electrical wiring board and/or about copper electrical conductors in illustrative embodiments of the invention.

The solder joints made with the new Sn—Ag—Cu—Mn (Pb-free) solder alloy may need to accommodate some minor addition of Pb due to reflow and mixing with Sn—Pb component lead plating during reflow assembly of solder joints. Slight contamination by such small Pb levels is not expected to raise the beneficial (about 211 degrees C.) melting point of the new Sn—Ag—Cu—Mn solder alloys and may even help improve the wettability during joint formation. This type of Pb-tolerant behavior is an advantage over competing Sn—Ag—Bi (Pb-free) solders that run the risk of generating an extremely low melting Sn—Pb—Bi ternary eutectic, if alloyed with Sn—Pb component platings. It is expected that the global supply of “legacy” electronic components with Sn—Pb solder plating will continue to diminish and eventually vanish during the current transition to full Pb-free electronic soldering, but this possibility must be tolerated in any new Pb-free solders that are proposed.

The Sn—Ag—Cu—Mn (SACM) solder alloy exhibits the significantly reduced melting point (melting temperature) of about 211 degrees C. as compared to the melting points of SAC ternary eutectic solder (217 degrees C.), the Sn—Ag binary eutectic solder (221 degrees C.), and the Sn—Cu binary eutectic solder (227 degrees C.). This significantly reduced melting point is a great advantage for solder assembly of electronic circuits and electrical systems. In the type of solder paste reflow and ball grid array (BGA) applications that are envisioned for use with the SACM solder, every single degree of reduced reflow temperature is a precious advantage for reducing damage to temperature sensitive electronic components and to the circuit board material, itself. In fact, a reason that SAC solder came into broad use as a Pb-free alternative to Sn—Pb solder is that the minimum reflow temperature of SAC solder for most applications, about 240 degrees C., is just below the threshold for significant damage of one of the most popular circuit board materials, a fiberglass/epoxy composite, i.e., FR-4. Thus, the SACM solder alloy pursuant to the present invention should permit a more comfortable margin for preventing thermal damage of most components and common circuit board materials.

It should also be mentioned that the use of the SACM solder alloy balls (e.g. spheres) according to an embodiment of the invention for BGA applications may also involve the use of a small deposit of a solder paste with a different composition, typically a SAC305 solder paste referred to above. The function of this paste is to cause adherence of each solder ball to the proper spot on the conductor array pattern during handling to prepare for reflow. During heating in the reflow operation with the SAC305 solder paste, for example, each SACM solder ball will melt first at about 211 degrees C. before the paste deposit starts to melt at 217 degrees C. During further heating to complete the reflow operation some alloying of the SACM solder ball will occur while both solder components are molten above 217 degrees C. that may cause a composition gradient or some minor dilution of the Mn in the interfacial region of the substrate. However, the relative volume of each SACM solder ball normally is overwhelming relative to its corresponding paste deposit and the beneficial effect of the initial Mn content of each SACM solder ball on promoting BGA joint solidification with low undercooling and suppression of Ag₃Sn blades is not expected to diminish.

The above advantages of the invention will become more readily apparent from the following detailed description taken with the following drawings.

### BRIEF DESCRIPTION OF THE DRAWINGS

FIG. 1 illustrates solder joint undercooling results for the base SAC3595 solder (Sn-3.5% Ag-0.95% Cu- % by weight) and as a function of concentration of X addition for the solder alloy where X=Mn addition to the base SAC3595 solder alloy for DSC (differential scanning calorimetry) measurements at 0.17° C./sec cooling rate.

FIG. 2 shows a summary of DSC results for SAC3595+0.10Mn solder joints (i.e. 0.10 wt. % Mn).

FIG. 3 is a typical SEM micrograph (scanning electron micrograph) of a SAC3595+0.10 wt. % Mn solder joint.

FIG. 4 shows a summary of an expanded region of the heating thermograms for the three Mn concentration levels tested (0.05%, 0.10%, 0.15% by weight Mn) as substitutional additions (for Cu) to SAC3595.

FIG. 5 is a SEM micrograph of the matrix region of a solder joint made with SAC3595+0.10Mn, showing the MnSn₂ intermetallic compound phases in the Sn metal phase.

FIGS. 6a and 6b are optical photographs of solder joints made with SAC3595+0.10 wt. % Mn that each join Cu blocks (2.5×2.5×0.5 cm) at a peak reflow temperature of 235° C. (FIG. 6a) and 255° C. (FIG. 6b).

### DETAILED DESCRIPTION OF THE INVENTION

The present invention involves reducing the unusually high undercooling of SAC (Sn—Ag—Cu) solder joints described above, where there can be difficulty in nucleating Sn solidification as a pro-eutectic phase, especially during slow cooling, such as existing for ball grid array (BGA) joints. As mentioned above, increased undercooling of the solder joints can promote formation of undesirable pro-eutectic intermetallic phases, specifically Ag₃Sn “blades,” that tend to coarsen radically, leading to embrittlement of as-solidified solder joints.

In an embodiment of the present invention, a quaternary alloy is provided comprising Sn, Ag, Cu, and Mn wherein the alloy composition exhibits a melting temperature of about 211 degrees C., which is well below the melting temperature of other SAC solder alloys. The quaternary Sn—Ag—Cu—Mn alloy typically exhibits a liquid plus solid temperature range of less than about 6 degrees C., often less than about 4 degrees C. Other alloying elements may be present in the solder alloy that do not substantially affect the melting temperature thereof.

An illustrative embodiment of the invention provides a Pb-free solder alloy consisting essentially of about 3 to about 4 weight % Ag, about 0.80 to about 1.0 weight % Cu, and about 0.05 to about 0.15 weight % Mn, and balance consisting essentially of Sn.

Another illustrative embodiment of the invention provides a Pb-free solder alloy consisting essentially of about 3 to about 4 weight % Ag, 0.95-y weight % Cu, and y weight % Mn and balance consisting essentially of Sn wherein y is about 0.05 to about 0.15 weight %.

A still further illustrative embodiment of the invention provides a Pb-free solder alloy comprising Sn, Ag, Cu, and Mn and having four different phases including three different intermetallic phases and a Sn metal phase. For example, the intermetallic phases include a phase comprising Sn and Mn (probably MnSn₂), Cu₆Sn₅ phase, and Ag₃Sn phase.

For purposes of further illustrating the invention without limiting it, the present invention is described below with respect to modifying a near-eutectic alloy, SAC3595 solder alloy (Sn-3.5% Ag-0.95% Cu, in weight %) as a base by alloying with a fourth element, Mn (manganese) to reduce undercooling of solder joints. In modifying base SAC3595 solder alloy, Mn was alloyed with the base solder alloy to promote nucleation of pro-eutectic Cu₆Sn₅ within the solder joint matrix (liquid alloy) in addition to its formation on the substrate interface, providing additional interfacial area for Sn nucleation. Also, the Mn addition promotes formation of a Sn—Mn intermetallic phase (probably MnSn₂) that may enhance heterogeneous nucleation of Sn. The Mn addition also may strain the lattice of the Cu₆Sn₅ phase, in both pro-eutectic and interfacial layer phases, to make a more potent epitaxial nucleation catalyst for Sn, thus reducing the joint undercooling and the potential to form Ag₃Sn blades, although applicants do not intend or wish to be bound by any theory in this regard.

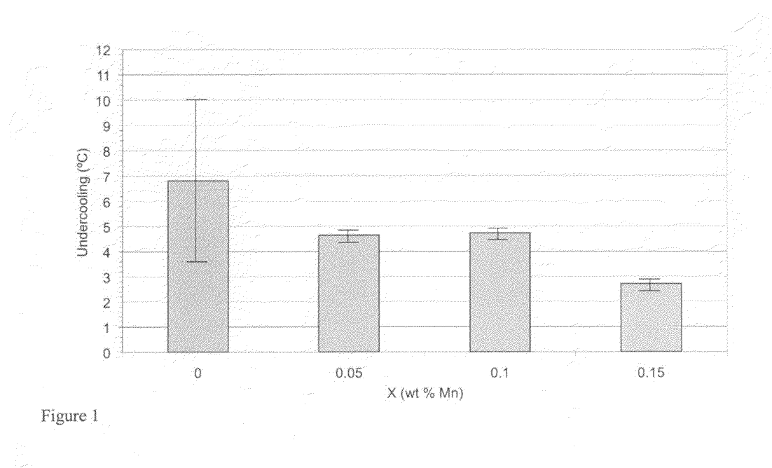

The bulk undercooling measurements for the solder joints made from the SAC3595+Mn alloys that were selected (i.e. Mn=0.05%, 0.10% and 0.15% by weight) are summarized in FIG. 1. For each Mn concentration level tested, at least 7 repeated trials were used. Inspection shows that the Mn addition is an active catalytic addition since these concentrations of Mn have relatively lower undercooling values as compared to the average undercooling of unmodified SAC3595 base solder alloy. The range of undercooling values for unmodified SAC3595 is indicated in FIG. 1 by the left-hand bar at the zero concentration, with the data spread indicated by the bracket. Mn can be seen to have a potent and consistent nucleation effect. Note that the nucleation temperature (T_{nuc.}) is defined as the onset point of the exothermic crystallization peak in each DSC thermogram, consistent with the literature in this field. Also, the bulk undercooling, ΔT, is defined at the difference between the onset of melting at the solidus temperature (Tₛₒₗ) and the onset of nucleation, i.e., ΔT=Tₛₒₗ−T_{nuc}. Also note that observation on heating in a differential scanning calorimeter (DSC) of the solidus temperature for a eutectic alloy is also the singular eutectic melting point, Tₑᵤₜ, and not just the start of a melting range between solidus and liquidus temperatures. The DSC apparatus used was a Pyris 1 power compensating DSC available from Perkin-Elmer.

Importantly, the calorimetric results for the Mn addition to the SAC3595 base solder alloy show a very potent effect on suppressing undercooling, FIG. 1, and are also correlated or indexed to a new lower melting onset (solidus temperature) of about 211 degrees C., shown in Table 1 for Mn additions of 0.05%, 0.10% and 0.15% by weight for alloys in accordance with the present invention. As specific evidence of the consistency of the observations from the calorimetric results for the Mn additions to SAC3595, Table 1 gives a complete summary of the melting and solidification observations. The depression of the melting temperature to about 211 degrees C. is unique for the Mn-modified alloys as compared to calorimetry data for SAC3595, which exhibits a consistent solidus temperature of 217 degrees C.

Furthermore, a comparison to other undercooling data published for SAC105 and SAC105+Mn [see reference 1] revealed an essentially consistent solidus temperature that varies from a minimum of 217.13 degrees C. (for Sn-1.07Ag-0.47Cu-0.085Mn) to a maximum of 217.81 degrees C. (for Sn-1.13Ag-0.6Cu-0.16Mn). Other results from this reference for SAC+Mn alloys with higher levels of Ag and Cu reveal a solidus temperature of 217.18 degrees C. (for Sn-1.76Ag-0.68Cu-0.15Mn) and of 217.43 degrees C. (for Sn-2.59Ag-0.65Cu-0.12Mn). An alloy of Sn-1.0Ag-0.46Cu-0.3 Bi-0.0.1Mn exhibited a slightly reduced solidus temperature of 216.22 degrees C., but it had a Bi addition as well as Mn.

TABLE 1
Summary of DSC Results for Mn Additions to SAC3595

| | | | | | | Mn |
|---|---|---|---|---|---|---|
| | | | | Enthalpy | Enthalpy | Conc. |
| | | | | of Melting | of Fusion | [wt. |
| Sample | T_{solidus} | T_{liquidus} | T_{nucleation} | [J/g] | [J/g] | %] |
| 1-096-01 | 211.62 | 214.14 | 206.59 | 62.549 | 60.876 | 0.05 |
| 1-096-02 | 211.19 | 214.21 | 206.75 | 63.788 | 61.992 | 0.05 |
| 1-096-03 | 211.26 | 215.12 | 206.65 | 63.417 | 61.953 | 0.05 |
| 1-096-04 | 211.41 | 214.72 | 206.65 | 63.711 | 61.641 | 0.05 |
| 1-096-05 | 211.41 | 214.37 | 206.66 | 63.545 | 61.258 | 0.05 |
| 1-096-06 | 211.14 | 214.21 | 206.46 | 63.217 | 60.796 | 0.05 |
| 1-096-07 | 211.03 | 214.1 | 206.74 | 63.748 | 62.049 | 0.05 |
| 1-096-08 | 211.29 | 215.05 | 208.37 | 62.293 | 60.699 | 0.10 |
| 1-096-09 | 211.15 | 214.83 | 208.31 | 62.73 | 61.428 | 0.10 |
| 1-096-10 | 211.26 | 214.97 | 208.77 | 62.197 | 61.881 | 0.10 |
| 1-096-11 | 211.02 | 214.99 | 208.21 | 62.932 | 61.341 | 0.10 |
| 1-096-12 | 211.35 | 215.39 | 208.69 | 62.137 | 61.158 | 0.10 |
| 1-096-13 | 211.09 | 215.6 | 208.52 | 62.396 | 61.881 | 0.10 |
| 1-096-14 | 211.11 | 215.25 | 208.39 | 62.542 | 62.001 | 0.10 |
| 1-098-01 | 211.42 | 214.11 | 206.47 | 62.026 | 62.793 | 0.15 |
| 1-098-02 | 211.18 | 214.6 | 206.56 | 62.001 | 61.662 | 0.15 |
| 1-098-03 | 211.27 | 214.61 | 206.84 | 62.802 | 63.156 | 0.15 |
| 1-098-04 | 211.42 | 214.58 | 206.71 | 62.98 | 62.813 | 0.15 |
| 1-098-05 | 211.34 | 215.06 | 206.64 | 62.771 | 62.68 | 0.15 |
| 1-098-06 | 211.16 | 214.42 | 206.55 | 62.812 | 61.853 | 0.15 |
| 1-098-07 | 211.33 | 214.4 | 206.23 | 63.097 | 63.092 | 0.15 |

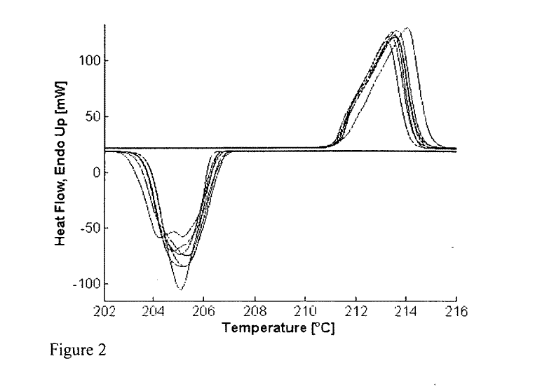

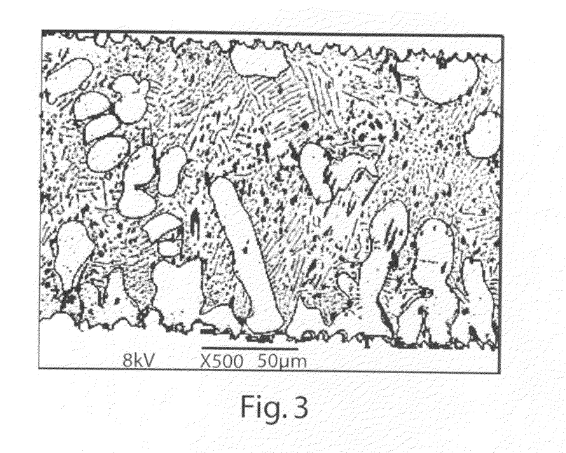

Referring to FIG. 2, the newly discovered solidus temperature of about 211 degree C. can be seen as the initial (upward) deviation from the baseline on heating to start the endothermic peak that represents solder joint melting in the DSC thermogram results summary in FIG. 2 for the SAC3595+0.10Mn alloy in accordance with the invention. Although not shown in FIG. 2, the heating baseline continues up to the peak reflow temperature of 240 degrees C. in these experiments without any other endothermic signals, consistent with the apparent completion of melting (liquidus temperature) at 214-215 degrees C., as recorded in Table 1. An SEM micrograph in FIG. 3 shows an example of one of the SAC3595+0.10Mn solder joints that solidified on cooling in one of the thermograms in FIG. 2, where the Cu substrates are shown on the top and bottom of the micrograph in dark contrast.

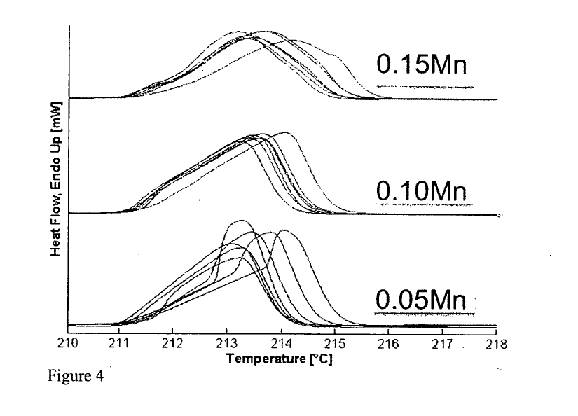

Moreover, the heating thermograms for the solder joints made from the three SAC3595+Mn alloy samples in accordance with the invention that were studied all display the same consistent melting onset temperature (solidus temperature) of about 211 degrees C. as shown in the summary of FIG. 4. However, each alloy thermogram in FIG. 4 shows some evidence for multiple (overlapping) endothermic peaks. Because of the significant depression of the melting onset by about 6 degrees C. below the normal Sn-3.5% Ag-0.95% Cu ternary eutectic temperature (nominally 217 degrees C.) by the substitutional addition of only 0.05 wt. % Mn into SAC3595 (Sn-3.5Ag-0.90Cu-0.05Mn), a new quaternary (perhaps a quaternary eutectic) solder alloy has been discovered in accordance with the invention. While undercooling can cause the solidification reaction to occur over a range of temperatures, the melting of a quaternary “eutectic” alloy should occur theoretically at a singular temperature, like a pure metal. From a comparison of the endothermic peak shapes of the three alloys in FIG. 3, it is thought that the quaternary (perhaps quaternary eutectic) alloy composition is probably closest to Sn-3.5% Ag-0.85% Cu-0.10% Mn (in weight %), termed SAC3595+0.10Mn, since these peaks seem to be the most singular and to have the narrowest apparent melting range. This observation can be confirmed by a series of melting and solidification studies at slower heating (and cooling) rates. The SAC3595+0.10Mn alloy nevertheless is a preferred representative of the newly discovered quaternary solder in accordance with the invention.

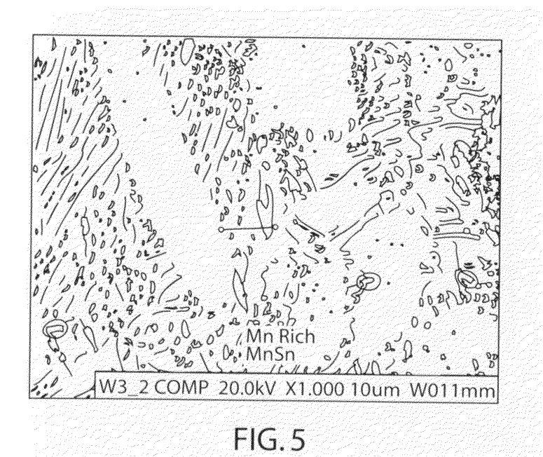

Another verification of this quaternary (perhaps quaternary eutectic) solder alloy must come from the identification of an additional phase in the solidified microstructure of these solder joints, since a quaternary eutectic reaction must have four product phases that solidify from a single phase alloy liquid. FIG. 5 provides an SEM micrograph of the solder matrix region of a SAC3595+0.10Mn joint similar to that in FIG. 3, but at a higher magnification and after ion surface etching. In this microstructure, the quaternary eutectic was found to be composed of β-Sn, Cu₆Sn₅, Ag₃Sn, and a Mn-containing compound (probably MnSn₂). Wavelength dispersive spectroscopy (WDS) analysis shows that all of the first three phases (β-Sn, Cu₆Sn₅, Ag₃Sn) are present, along with a Sn—Mn compound (probably MnSn₂) with up to about 27 at. % Mn. Unfortunately, the Sn—Mn micron sized particles (circled on the micrograph) are too small for high precision quantitative WDS measurement due to their size relative to the electron-specimen interaction volume. However, the phase diagram for the Mn—Sn system allows estimation that MnSn₂ is the closest phase corresponding to the WDS measurements. The presence of this fourth Sn—Mn phase combined with the reduced liquidus and solidus temperatures are strong evidence that a new quaternary eutectic solder has been discovered pursuant to the invention.

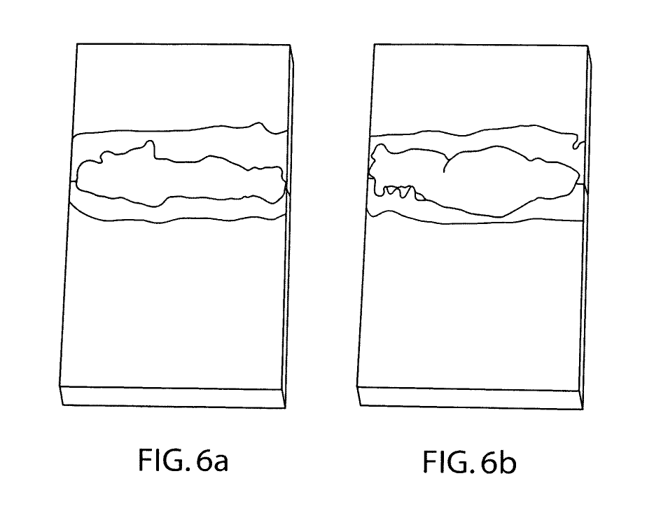

The reduced melting temperature of SACM solder pursuant to the invention is a great advantage, as described above. To evaluate solderability of the SACM solder, macroscopic solder joints of SAC3595+0.10Mn were produced in ambient air at a reduced reflow temperature of 235 degrees C. (see FIG. 6a) and at an elevated reflow temperature of 255 degrees C. (FIG. 6b) to check for the ability to penetrate a long narrow joint gap and to wet the surface of the Cu substrates. FIGS. 6a and 6b illustrate the effects of temperature on this SACM solder surface, with the FIG. 6a joint produced at 235 degrees C. having some reduction in the golden oxide color, compared to the same solder used to prepare the FIG. 6b joint at 255 degrees C. While the wetting angle of the surface solder puddle for both conditions does not look to be much less than 90 degrees, a common definition for acceptable solder wettability, sectioning of the solder joints showed that the interior gap was completely wetted and filled for both. Thus, this is an indication of sufficient solderability, even in open air, which is desirable for manufacturing simplicity.

The present invention thus provides a solder joint and solder process that embody the SACM (Sn.Sg—Cu—Mn) alloy. The solder joint has a microstructure having four different phases including three different intermetallic phases, such as the Cu₆Sn₅ phase, Ag₃Sn phase, and Sn—Mn phase (probably MnSn₂), together with the Sn metal phase, i.e. β-Sn phase. The solder joint is formed by the solder being solidified on an electrical wiring board about copper electrical conductors thereof in illustrative embodiments of the invention. The solder can be incorporated into an electronic solder paste and used for circuit assembly to this end.

The Sn—Ag—Cu—Mn (SACM) solder alloy of the present invention is advantageous in that the alloy exhibits the significantly reduced melting point (melting temperature) of about 211 degrees C. as compared to the melting points of SAC ternary eutectic solder (217 degrees C.), the Sn—Ag binary eutectic solder (221 degrees C.), and the Sn—Cu binary eutectic solder (227 degrees C.). This significantly reduced melting point is a great advantage for solder assembly of electronic circuits and electrical systems. In the type of solder paste reflow and ball grid array applications that are envisioned for use with the SACM solder, every single degree of reduced reflow temperature is a precious advantage for reducing damage to temperature sensitive electronic components and to the circuit board material, itself. In fact, a reason that SAC solder came into broad use as a Pb-free alternative to Sn—Pb solder is that the minimum reflow temperature of SAC solder for most applications, about 240 degrees C., is just below the threshold for significant damage of one of the most popular circuit board materials, a fiberglass/epoxy composite, i.e., FR-4. Thus, the SACM solder alloy pursuant to the present invention should permit a more comfortable margin for preventing thermal damage of most components and common circuit board materials. For use in solder paste reflow and ball grid array applications, the invention envisions providing solder balls, such as substantially solder spheres or near-spheres, comprising the invention solder alloy in a solder ball size range of about 100 microns to 1000 microns diameter for purposes of illustration and not limitation.

The Sn—Ag—Cu—Mn (SACM) solder alloy of the present invention should be useful for low temperature reflow of Pb-free solder paste and BGA balls (e.g. spheres) as well as other soldering applications.

Another important advantage of the SACM solder pursuant to the invention involves reduction or avoidance of the formation of Ag₃Sn blades in the as-solidified solder joint microstructure. Analysis of all of the solder joint samples for the full range of Mn additions revealed that a minimum of 0.10% by weight Mn appears to completely suppress Ag₃Sn blade phase formation, even at the slow cooling rate that is common for BGA assembly. This high level of control of the solder joint microstructure should produce superior results in board level impact conditions, but this also remains to be verified by such full scale testing.

While the invention has been described in terms of specific embodiments thereof, those skilled in the art will appreciate that modifications and changes can be made thereto within the scope of the appended claims.

1. An alloy comprising Sn, Ag, Cu, and Mn and having a melting temperature of about 211 degrees C.

2. The alloy of claim 1 having a liquid plus solid temperature range less than about 6 degrees C.

3. The alloy of claim 1 having three different intermetallic phases and a Sn metal phase.

4. The alloy of claim 3 wherein the intermetallic phases include a phase comprising Sn and Mn.

5. The alloy of claim 4 wherein the phase is MnSn₂.

6. The alloy of claim 3 wherein other intermetallic phases include Cu₆Sn₅, and Ag₃Sn.

7. An alloy consisting essentially of about 3 to about 4 weight % Ag, about 0.80 to about 1.0 weight % Cu, and about 0.05 to about 0.15 weight % Mn, and balance consisting essentially of Sn.

8. The alloy of claim 7 including at least about 0.10 weight % Mn.

9. An alloy consisting essentially of about 3 to about 4 weight % Ag, 0.95-y weight % Cu, and y weight % Mn and balance consisting essentially of Sn wherein y is about 0.05 to about 0.15 weight %.

10. The alloy of claim 9 including at least about 0.10 weight % Mn.

11. An alloy comprising Sn, Ag, Cu, and Mn and having three different intermetallic phases and a Sn metal phase.

12. The alloy of claim 11 wherein the intermetallic phases include a phase comprising Sn and Mn.

13. A solder joint comprising a Pb-free solder solidified in contact with an electrical conductor wherein said solder comprises Sn, Ag, Cu, and Mn and has a melting temperature of about 211 degrees C.

14. The joint of claim 13 having three different intermetallic phases and a Sn metal phase.

15. The joint of claim 13 wherein the intermetallic phases include a phase comprising Sn and Mn.

16. The joint of claim 15 wherein the phase comprises MnSn₂.

17. The joint of claim 13 wherein other intermetallic phases include Cu₆Sn₅, and Ag₃Sn.

18. The joint of claim 13 formed on an electrical wiring board.

19. The joint of claim 13 formed about copper electrical conductors.

20. A solder joint comprising a Pb-free solder solidified in contact with an electrical conductor wherein said joint consists essentially of about 3 to about 4 weight % Ag, about 0.80 to about 1.0 weight % Cu, and about 0.05 to about 0.15 weight % Mn, and balance consisting essentially of Sn.

21. The joint of claim 20 including at least about 0.10 weight % Mn.

22. The joint of claim 20 formed on an electrical wiring board.

23. The joint of claim 20 formed about copper electrical conductors.

24. A solder joint comprising a Pb-free solder solidified in contact with an electrical conductor wherein the joint consists essentially of about 3 to about 4 weight % Ag, 0.95-y weight % Cu, and y weight % Mn and balance consisting essentially of Sn wherein Mn is about 0.05 to about 0.15 weight %.

25. The joint of claim 24 including at least about 0.10 weight % Mn.

26. The joint of claim 24 formed on an electrical wiring board.

27. The joint of claim 24 formed about copper electrical conductors.

28. A solder joint comprising a Pb-free solder solidified in contact with an electrical conductor wherein the joint comprises Sn, Ag, Cu, and Mn and includes three intermetallic phases and a Sn metal phase.

29. The joint of claim 28 formed on an electrical wiring board.

30. The joint of claim 28 formed about copper electrical conductors.

31. In a soldering process, the step of solidifying a molten Pb-free solder comprising Sn, Ag, Cu, and Mn and having a melting temperature of about 211 degrees C.

32. The process of claim 31 wherein the solder is solidified on an electrical wiring board.

33. The process of claim 31 wherein the solder is solidified about copper electrical conductors.

34. In a soldering process, the step of solidifying a molten Pb-free solder consisting essentially of about 3 to about 4 weight % Ag, about 0.80 to about 1.0 weight % Cu, and about 0.05 to about 0.15 weight % Mn, and balance consisting essentially of Sn.

35. The process of claim 34 wherein the solder includes at least about 0.10 weight % Mn.

36. The process of claim 34 wherein the solder is solidified on an electrical wiring board.

37. The process of claim 34 wherein the solder is solidified about copper electrical conductors.

38. In a solder process, the step of solidifying a molten Pb-free solder consisting essentially of about 3 to about 4 weight % Ag, 0.95-y weight % Cu, and y weight % Mn and balance consisting essentially of Sn wherein Mn is about 0.05 to about 0.15 weight %.

39. The process of claim 38 wherein the solder includes at least about 0.10 weight % Mn.

40. The process of claim 38 wherein the solder is solidified on an electrical wiring board.

41. The process of claim 38 wherein the solder is solidified about copper electrical conductors.

42. In a solder process, the step of solidifying a molten Pb-free solder comprising Sn, Ag, Cu, and Mn in a manner that the solidified solder microstructure includes three intermetallic phases and a Sn metal phase.

43. The process of claim 42 wherein one intermetallic phase comprises Sn and Mn

44. The process of claim 43 wherein the phase comprises MnSn₂.

45. The process of claim 42 wherein the solder is solidified on an electrical wiring board.

46. The process of claim 42 wherein the solder is solidified about copper electrical conductors.

47. A solder ball comprising an alloy comprising Sn, Ag, Cu, and Mn and having a melting temperature of about 211 degrees C.

48. The solder ball of claim 47 having a liquid plus solid temperature range less than about 6 degrees C.

49. The solder ball of claim 47 having three different intermetallic phases and a Sn metal phase.

50. The solder ball of claim 49 wherein the intermetallic phases include a phase comprising Sn and Mn.

51. The solder ball of claim 50 wherein the phase is MnSn₂.

52. The solder ball of claim 49 wherein other intermetallic phases include Cu₆Sn₅, and Ag₃Sn.

53. A solder ball comprising an alloy consisting essentially of about 3 to about 4 weight % Ag, about 0.80 to about 1.0 weight % Cu, and about 0.05 to about 0.15 weight % Mn, and balance consisting essentially of Sn.

54. The solder ball of claim 53 including at least about 0.10 weight % Mn.

55. A solder ball comprising an alloy consisting essentially of about 3 to about 4 weight % Ag, 0.95-y weight % Cu, and y weight % Mn and balance consisting essentially of Sn wherein y is about 0.05 to about 0.15 weight %.

56. The solder ball of claim 55 including at least about 0.10 weight % Mn.

57. A solder ball comprising an alloy comprising Sn, Ag, Cu, and Mn and having three different intermetallic phases and a Sn metal phase.

58. The solder ball of claim 57 wherein the intermetallic phases include a phase comprising Sn and Mn.
